(19) United States
(12) Patent Application Publication
(10) Pub. No.: US 2026/0010415 A1
(43) Pub. Date: Jan. 8, 2026

(54) CONTROL PROCESSOR POWER CONSUMPTION

(71) Applicant: Dell Products L.P., Round Rock, TX (US)

(72) Inventors: Owen Martin, Hopedale, MA (US); Ramesh Doddaiah, Westborough, MA (US)

(73) Assignee: Dell Products L.P., Round Rock, TX (US)

(21) Appl. No.: 18/762,726

(22) Filed: Jul. 3, 2024

(51) Int. Cl. G06F 9/50; G06F 1/28

(52) U.S. Cl. CPC G06F 9/5094; G06F 1/28

(57) ABSTRACT

One or more aspects of the present disclosure relate to controlling the power consumption of processor resources. In embodiments, one or more performance metrics for processing local and replication workloads are monitored by a remote data facility (RDF) storage array. In addition, power consumption of processor resources of the RDF storage array can be controlled based on the local and replication input/output (IO) workloads and service level (SL) requirements corresponding to each storage group targeted by IO operations of the local and replication IO workloads.

### BACKGROUND

A storage array performs block-based, file-based, or object-based storage services. Rather than store data on a server, storage arrays can include multiple storage devices (e.g., drives) to store vast amounts of data. For example, a financial institution can use storage arrays to collect and store financial transactions from local banks and automated teller machines (ATMs) related to bank account deposits/withdrawals. In addition, businesses like financial institutions can use Remote Data Facility (RDF) systems to replicate data stored on a storage array at a remote location. Specifically, RDF systems can handle large volumes of data across multiple locations, ensuring data replication and availability for various business applications.

### SUMMARY

One or more aspects of the present disclosure relate to controlling the power consumption of processor resources. In embodiments, one or more performance metrics for processing local and replication workloads are monitored by a remote data facility (RDF) storage array. In addition, power consumption of processor resources of the RDF storage array can be controlled based on the local and replication input/output (IO) workloads and service level (SL) requirements corresponding to each storage group targeted by IO operations of the local and replication IO workloads.

In embodiments, the RDF storage array can periodically receive a composable core matrix (CCM) defining processor resource allocations of a source storage array of the replication workloads.

In embodiments, SL assignments of each central processing unit (CPU) pool of the source storage array can be determined using the CCM of the source storage array. Additionally, CPU core allocations per CPU pool of the source storage array can be determined using the CCM of the source storage array. Further, the CCM can define the CPU core allocations of each CPU pool based on historical, current, and forecasted IO workload demands and response times of each storage group corresponding to the source storage array.

In embodiments, the historical, current, and forecasted IO workload demands can correspond to input/output (IO) operations per second (IOPS) corresponding to each storage group.

In embodiments, CPU clock speed settings corresponding to each CPU pool of the source storage array can be determined using the CCM of the source storage array.

In embodiments, IOPS demand and response times corresponding to each storage group of the RDF storage array can be forecasted based on the monitored performance metrics of the local workloads processed by the RDF storage array.

In embodiments, a composite CCM corresponding to the RDF storage array can be generated using the CCM of the source storage array and the forecasted IOPS demand and response times corresponding to each storage group of the RDF storage array. In addition, the CCM can control processor power consumption by defining the CPU clock speed settings corresponding to each CPU pool of the RDF storage array.

In embodiments, the composite CCM can be generated to define CPU pools for each SL requirement and adjustments to CPU core allocations amongst the CPU pools based on the CCM of the source storage array and the forecasted IOPS demand and response times corresponding to each storage group of the RDF storage array.

In embodiments, CPU cores can be dynamically promoted or demoted amongst the CPU pools to satisfy SL response time targets corresponding to each storage group of the RDF storage array using the composite CCM.

In embodiments, a CPU core allocation of a subject CPU pool can be increased when one or more storage groups corresponding to the subject CPU pool are above response time targets. Further, the CPU core allocation of the subject CPU pool can be decreased when one or more storage groups corresponding to the subject CPU pool are below response time targets while maintaining a baseline threshold of CPU cores for the subject CPU pool.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments' principles.

FIG. 1 illustrates a distributed network environment in accordance with embodiments of the present disclosure.

FIG. 2 is a cross-sectional view of a storage device in accordance with embodiments of the present disclosure.

FIG. 3 is a block diagram of a communications network, including a storage array and a remote data facility (RDF) in accordance with embodiments of the present disclosure.

FIG. 4 is a block diagram of a controller in accordance with embodiments of the present disclosure.

FIG. 5 is a block diagram of a Composable Central Processing Unit (CPU) Core Matrix per embodiments of the present disclosure.

FIG. 6 is a flow diagram of a method for controlling the power consumption of processor resources per embodiments of the present disclosure.

### DETAILED DESCRIPTION

A business like a financial or technology corporation can produce large amounts of data and require sharing access to that data among several employees. Such a business often uses storage arrays to store and manage the data. Because a storage array can include multiple storage devices (e.g., hard-disk drives (HDDs) or solid-state drives (SSDs)), the business can scale (e.g., increase or decrease) and manage an array's storage capacity more efficiently than a server. In addition, the business can use a storage array to read/write data required by one or more business applications.

In addition, businesses like financial institutions can use Remote Data Facility (RDF) systems to ensure data availability and integrity across geographically dispersed locations. For example, RDF systems can replicate data stored on a storage array at a remote location. Additionally, RDF systems are crucial for various applications, from disaster recovery to real-time data replication and access.

Current naive RDF systems employ static resource allocation strategies where CPU cores operate at uniform clock speeds regardless of the varying demands of different tasks. This approach, while simplifying system design, leads to significant inefficiencies. For instance, uniform CPU speeds mean that low-priority tasks may consume the same amount of power as high-priority tasks, leading to unnecessary power consumption and increased operational costs. Moreover, this can result in suboptimal performance, especially when system resources are not aligned with the processing needs dictated by the workload's criticality and service level requirements.

Furthermore, existing systems lack the flexibility to dynamically adjust CPU resources in response to real-time changes in data traffic and workload characteristics. This limitation is particularly problematic in today's data-driven environments, where the volume and velocity of data can fluctuate dramatically. The inability to adapt CPU utilization to changing conditions affects system performance. It also impedes the ability to meet predefined service level agreements (SLAs), which are crucial for maintaining customer trust and satisfaction.

Embodiments of the present disclosure relate to managing and optimizing processor resources in a Remote Data Facility (RDF) storage array, which is crucial for efficiently handling local and replication workloads. For example, the embodiments can intelligently manage CPU resources to optimize power consumption and enhance performance in line with varying workload demands. Specifically, the embodiments can dynamically adjust CPU allocations based on real-time performance metrics, ensuring each task receives the appropriate resources according to its priority and service level requirements. Advantageously, the embodiments improve the efficiency and reliability of RDF systems and contribute to broader sustainability goals by reducing the energy footprint of data centers, as described in greater detail herein.

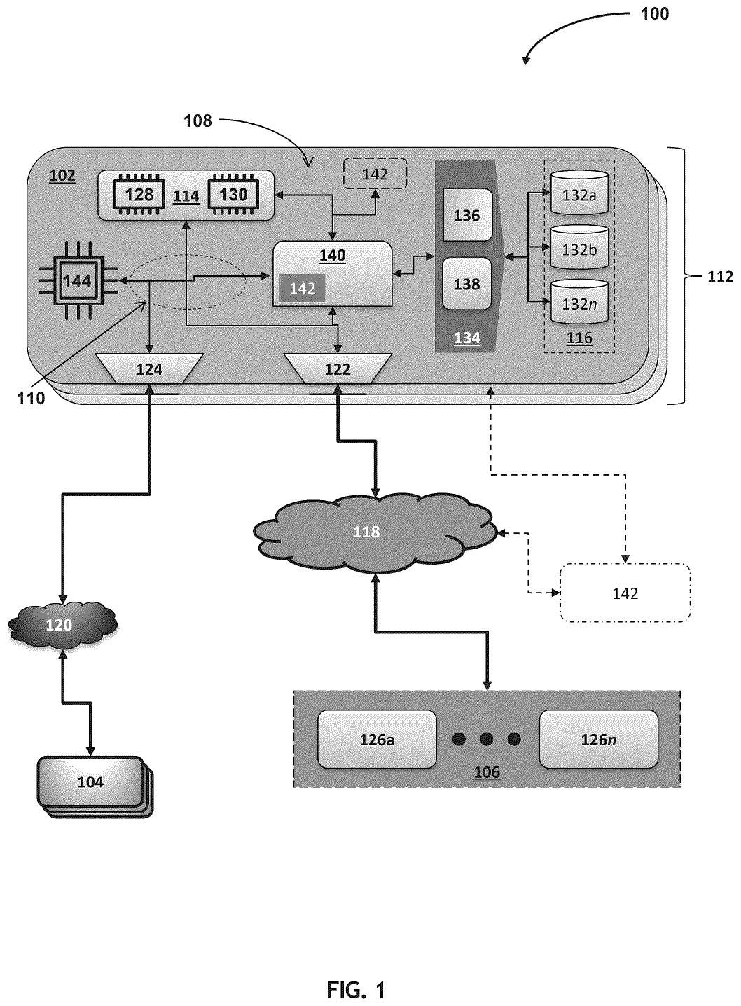

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 110 like Fibre channels, busses, and communication modules that communicatively couple the components 108. Further, the distributed network environment 100 can define an array cluster 112, including the storage array 102 and one or more other storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and the like. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Further, the network 118 or the remote network 120 can have a network architecture that enables networked devices to send/receive electronic communications using a communications protocol. For example, the network architecture can define a storage area network (SAN), local area network (LAN), wide area network (WAN) (e.g., the Internet), an Explicit Congestion Notification (ECN), Enabled Ethernet network, and the like. Additionally, the communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (ISCSI) protocol, NVMe-over-fabrics protocol (e.g., NVMe-over-ROCEv2 and NVMe-over-TCP), and the like.

Further, the storage array 102 can connect to the network 118 or remote network 120 using one or more network interfaces. The network interface can include a wired/wireless connection interface, bus, data link, and the like. For example, a host adapter (HA 122), e.g., a Fibre Channel Adapter (FA) and the like, can connect the storage array 102 to the network 118 (e.g., SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, infrared light beams, etc. The communication nodes can also include switching equipment, phone lines, repeaters, multiplexers, and satellites. Further, the network 118 or remote network 120 can include a network bridge that enables cross-network communications between, e.g., the network 118 and remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Further, the IO messages can include metadata defining performance requirements according to a service level agreement (SLA) between hosts 106 and the storage array provider.

In embodiments, the storage array 102 can include a memory 114, such as volatile or nonvolatile memory. Further, volatile and nonvolatile memory can include random access memory (RAM), dynamic RAM (DRAM), static RAM (SRAM), and the like. Moreover, each memory type can have distinct performance characteristics (e.g., speed corresponding to reading/writing data). For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and GPUs (graphical processing units).

In addition, the storage array 102 can deliver its distributed storage services using persistent storage 116. For example, the persistent storage 116 can include multiple thin-data devices (TDATs) such as persistent storage drives 132a-n. Further, each TDAT can have distinct performance capabilities (e.g., read/write speeds) like hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136) (e.g., storage device controller), flash drive interface 138, and the like that control access to the array's persistent storage 116 (e.g., storage devices 132a-n).

Likewise, the storage array 102 can include an Enginuity Data Services processor (EDS 140) that can manage access to the array's memory 114. Further, the EDS 140 can perform one or more memory and storage self-optimizing operations (e.g., one or more machine learning techniques) that enable fast data access. Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote/distributed storage services by virtualizing the storage array's memory/storage resources (memory 114 and persistent storage 116, respectively).

In embodiments, the storage array 102 can also include a controller 142 (e.g., management system controller) that can reside externally from or within the storage array 102 and one or more of its components 108. When external from the storage array 102, the controller 142 can communicate with the storage array 102 using any known communication connections. For example, the communications connections can include a serial port, parallel port, network interface card (e.g., Ethernet), etc. Further, the controller 142 can include logic/circuitry that performs one or more storage-related services. For example, the controller 142 can have an architecture designed to manage the storage array's computing, processing, storage, and memory resources as described in greater detail herein.

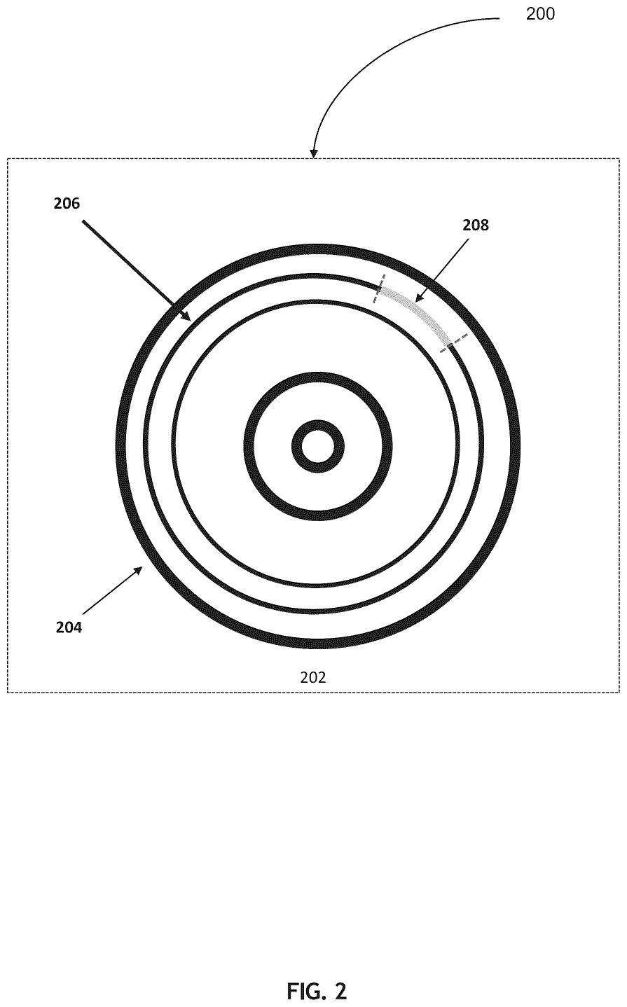

Regarding FIG. 2, the storage array's EDS 140 can virtualize the array's persistent storage 116. Specifically, the EDS 140 can virtualize a storage device 200, which is substantially like one or more of the storage devices 132a-n. For example, the EDS 140 can provide a host, e.g., client machine 126a, with a virtual storage device (e.g., thin-device (TDEV)) that logically represents zero or more portions of each storage device 132a-n. For example, the EDS 140 can establish a logical track using zero or more physical address spaces from each storage device 132a-n. Specifically, the EDS 140 can establish a continuous set of logical block addresses (LBA) using physical address spaces from the storage devices 132a-n. Thus, each (LBA) represents a corresponding physical address space from one of the storage devices 132a-n. For example, a track can include 256 LBAs, amounting to 128 kb of physical storage space. Further, the EDS 140 can establish the TDEV using several tracks based on the desired storage capacity of the TDEV. The EDS 140 can also establish extents that logically define a group of tracks.

In embodiments, the EDS 140 can provide each TDEV with a unique identifier (ID) like a target ID (TID). Additionally, EDS 140 can establish a logical unit number (LUN) that maps each track of a TDEV to its corresponding physical track location using pointers. Further, the EDS 140 can also generate a searchable data structure, mapping logical storage representations to their corresponding physical address spaces. Thus, EDS 140 can enable the HA 122 to present the hosts 106 with logical storage representations based on host or application performance requirements.

For example, the persistent storage 116 can include an HDD 202 with stacks of cylinders 204. Like a vinyl record's grooves, each cylinder 204 can include one or more tracks 206. Each track 206 can include continuous sets of physical address spaces representing each of its sectors 208 (e.g., slices or portions thereof). The EDS 140 can provide each slice/portion with a corresponding logical block address (LBA). The EDS 140 can also group sets of continuous LBAs to establish one or more tracks. Further, the EDS 140 can group a set of tracks to establish each extent of a virtual storage device (e.g., TDEV). Thus, each TDEV can include tracks and LBAs corresponding to the persistent storage 116 or portions thereof (e.g., tracks and address spaces).

As stated herein, the persistent storage 116 can have distinct performance capabilities. For example, an HDD architecture is known by skilled artisans to be slower than an SSD's architecture. Likewise, the array's memory 114 can include different memory types, each with distinct performance characteristics described herein. In embodiments, the EDS 140 can establish a storage or memory hierarchy based on the SLA and the performance characteristics of the array's memory/storage resources. For example, the SLA can include one or more Service Level Objectives (SLOs) specifying performance metric ranges (e.g., response times and uptimes) corresponding to the hosts' performance requirements.

Further, the SLO can specify service level (SL) tiers corresponding to each performance metric range and categories of data importance (e.g., critical, high, medium, low). For example, the SLA can map critical data types to an SL tier requiring the fastest response time. Thus, the storage array 102 can allocate the array's memory/storage resources based on an IO workload's anticipated volume of IO messages associated with each SL tier and the memory hierarchy.

For example, the EDS 140 can establish the hierarchy to include one or more tiers (e.g., subsets of the array's storage and memory) with similar performance capabilities (e.g., response times and uptimes). Thus, the EDS 140 can establish fast memory and storage tiers to service host-identified critical and valuable data (e.g., Diamond, Platinum, and Gold service levels (SLs)). In contrast, slow memory and storage tiers can service host-identified, non-critical, less valuable data (e.g., Silver and Bronze SLs). The EDS 140 can also define “fast” and “slow” performance metrics based on relative performance measurements of the array's memory 114 and persistent storage 116. Thus, the fast tiers can include memory 114 and persistent storage 116, with relative performance capabilities exceeding a first threshold. In contrast, slower tiers can include memory 114 and persistent storage 116, with relative performance capabilities falling below a second threshold. Further, the first and second thresholds can correspond to the same threshold.

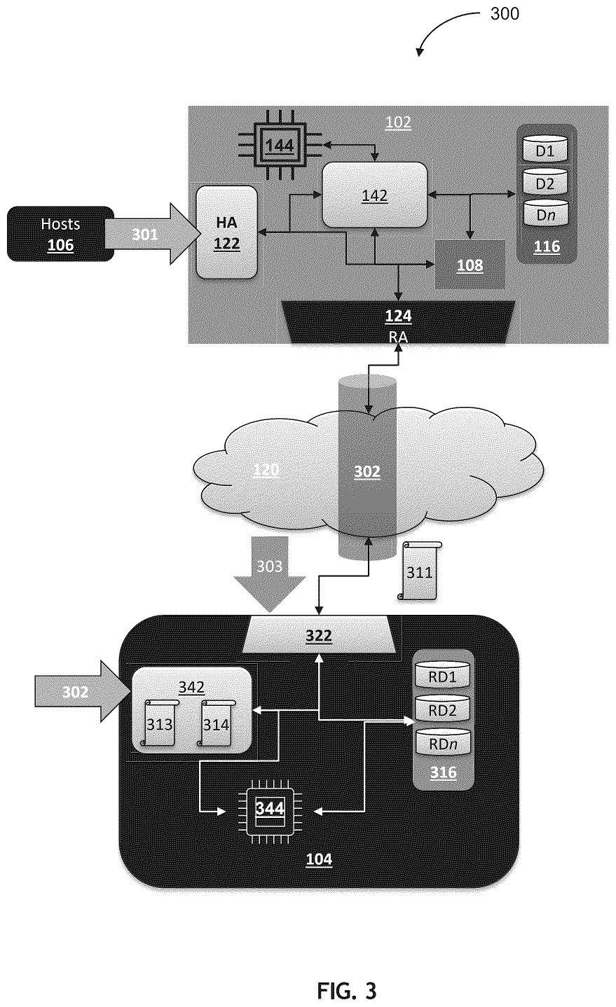

Regarding FIG. 3, a distributed network environment 300 can be substantially similar to the distributed network environment 100 of FIG. 1. For instance, the distributed network environment 300 can include a storage array 102, remote system 104, and hosts 106. In embodiments, the storage array 102 can receive an input/output (IO) workload 301 from the hosts 106. The storage array 102 can include a host adapter (HA) 122 that processes the IO workload 301. The HA 122 can classify the IO workload 301 and its IO operations. The classification can include identifying the type of IO operation (e.g., read, write, replication), IO size, and associating each operation with a specific service level (e.g., Diamond, Platinum, Gold, Silver, and Bronze).

In embodiments, a service level agreement (SLA) can define the level of service expected from a storage array (e.g., the storage array 102) or a remote system (e.g., the remote data facility (RDF) 104). Specifically, the SLA can define performance metrics for processing IO workloads (e.g., the IO workload 301) and their respective IO operations. The performance metrics can include throughput (e.g., data transfer rate in megabytes per second (MB/s) or gigabytes per second (GB/s)), Input/Output Operations Per Second (IOPS) (e.g., the minimum read and write operations the storage array should be able to handle per second), and latency (e.g., the maximum acceptable delay for an IO operation to be completed).

Further, the SLA can categorize IO operations into distinct priority levels (e.g., Diamond, Platinum, Gold, Silver, and Bronze SLs). Additionally, critical operations that affect core business functions might be classified at a higher priority level, requiring faster throughput and lower latency. Accordingly, the SLA can specify different performance metrics for each priority level, ensuring that critical operations are given priority over less critical tasks.

In embodiments, IO operations critical to business operations, such as financial transactions, real-time data analytics, or emergency response systems, can have a high priority level (e.g., Diamond or Platinum). The storage array 102 can give these high-priority level IO operations preferential access to resources (e.g., faster CPUs, more cache memory, and quicker storage media). Essential but not critical IO operations, such as batch processing jobs, standard database queries, or internal data transfers, can have a medium priority level (e.g., Gold or Silver). The storage array 102 can provide these medium-priority IO operations with adequate resources to ensure good performance without preempting resources from higher-priority tasks. Non-critical IO operations that can tolerate delays, such as backup operations, data archiving, or other maintenance-related tasks, can have a low priority level (e.g., Bronze). The storage array 102 can allocate resources not used by higher-priority tasks to these low-priority IO operations. Further, the storage array 102 can pause or slow down resource allocations for these low-priority IO operations during high system load to preserve performance for higher-priority IO operations.

In embodiments, the storage array 102 can include a controller 142 configured to manage one or more storage array resources (e.g., processor cores, memory, storage, etc.) to process the IO workload 301 and its IO operations. Accordingly, the controller 142 can allocate the storage array resources by forecasting characteristics corresponding to the IO workload 301 and its IO operations. The characteristics can include IO operation type (e.g., read vs. write or sequential vs. random), IO operation size (e.g., size of data blocks involved in the IO operation), frequency and intensity of IO operations (e.g., IOPS), duration and timing of IO operations (e.g., duration of the IO workload and temporal IO patterns), and the like.

The controller 142 can allocate processor resources 144 (e.g., CPU cores) into one or more pools. For instance, the controller 142 can establish thresholds for response times, IOPS, and power consumption metrics that define each pool. Additionally, the thresholds can correspond to each service level (e.g., Diamond, Platinum, Gold, Silver, and Bronze). Using the thresholds, the controller 142 can generate a composable processor (CPU) core matrix (e.g., the Composable CPU Core Matrix (CCM) 500 of FIG. 1) that categorizes the processor cores 144 into different pools, each corresponding to specific service levels. The composable processor core matrix can configure each pool with unique processor clock speed settings that are dynamically adjustable to meet the performance and power consumption criteria associated with its service level. Accordingly, the storage array 102 can process the IO workload 301 and its corresponding IO operations by allocating processor resources 144 using the composable core matrix.

Further, the controller 142 can use the composable processor core matrix (CCM) to optimize power consumption. The controller 142 can use the CCM to dynamically adjust CPU clock speeds and reallocate cores among different pools to minimize unnecessary power usage while maintaining optimal performance. For example, the controller 142 can determine potential power savings from reducing CPU speeds and compare these savings against the performance impact (e.g., response times) on the storage array 102. Accordingly, the controller 142 can use the CCM to adjust CPU settings to balance power savings with the need to meet SLA targets, ensuring that performance does not fall below acceptable levels.

In embodiments, the storage array (e.g., “local” or “source” array) 102 can be paired with a secondary storage array (e.g., “remote,” “target,” or “RDF” array) 104 located at a different geographical site. For instance, the storage array 102 can establish an RDF link 302 with the RDF array 104 over a network (e.g., the remote network 120). Accordingly, the storage array 102 can use the RDF array 104 as a data replication and disaster recovery solution, ensuring data availability and integrity across geographically dispersed locations. Accordingly, the RDF 104 can receive replication workloads 303, which include data and operations mirrored from the primary storage array 102 to the RDF 104.

The storage array 102 can also designate specific logical volumes or devices, representing one or more portions of storage devices D1-n of the storage array's persistent storage 116, for replication. In particular, the storage array 102 can logically group the designated volumes/devices for replication. For example, the storage array 102 can configure each group with specific replication properties, such as synchronous or asynchronous replication, depending on the required data protection level and performance impact.

In synchronous replication, every write IO operation from a host (e.g., one of the hosts 106) to the primary storage array (e.g., the storage array 102) is simultaneously replicated to the secondary storage array (e.g., the RDF 104). Further, the primary storage array waits for an acknowledgment from the secondary array before confirming the write IO operation to the host. Accordingly, synchronous replication guarantees that both arrays are always in sync and ensures zero data loss.

Asynchronous replication involves replicating data to the secondary array with a slight delay. The primary array does not wait for an acknowledgment for each write operation, which minimizes the impact on performance. This method is suitable for situations where some data loss is tolerable in exchange for higher throughput and lower latency.

In embodiments, the RDF 104 can receive local workloads 302 and replication workloads 303. The local workloads 302 can include the operations and processes initiated and managed directly within the RDF. For example, the RDF 104 can perform backup operations such as local backups of data stored in the persistent storage 316 of the RDF 104, which may not necessarily be replicated back to the primary storage array 102. The local backups can be crucial for disaster recovery and data integrity within the RDF 104. Likewise, the RDF 104 can perform maintenance tasks like defragmentation, integrity checks, and other routine maintenance operations that ensure the health and efficiency of the RDF 104. In addition, the RDF 104 can perform data analytics or processing tasks on replicated data corresponding to the replicated IO workloads 303 received from the primary storage array 102. Thus, businesses can use the RDF 104 for more than a failover site, turning it into an active processing node. Further, the RDF 104 can run applications that use the replicated data for various operation needs. These applications, such as local monitoring tools, can be specific to the RDF 104.

Additionally, the local workloads 302 and the replication workloads 303 can have different performance impacts on the RDF 104. Specifically, the RDF 104 can manage the local workloads 302 without the immediate pressure of impacting its performance. In contrast, the RDF 104 must handle the replication workloads 303 in a way that minimizes impact on its operations.

In particular, asynchronous replication jobs corresponding to the replication workloads 303 present unique challenges for forecasting due to their inherent characteristics and operational dynamics. Unlike synchronous replication, where data is replicated to the RDF 104 in real-time, and each operation waits for an acknowledgment, asynchronous replication allows for a delay between data being written at the storage array 102 and replicated to the RDF 104. This delay introduces complexities in predicting workload behaviors and system requirements.

For instance, the delay can result in variable latency, where the time lag can fluctuate based on network conditions, the volume of data being transferred, and system load. Accurately predicting these delays is challenging due to their dependence on fluctuating external factors. Additionally, asynchronous replication requires the RDF 104 to process data in bursts. For example, data might accumulate during peak operational hours and then get replicated during off-peak hours. This bursty nature leads to significant network and system load variations, making it difficult for the RDF 104 to predict when and how many resources will be needed.

In embodiments, the RDF 104 can regularly receive CCM data 311 corresponding to the primary storage array 102. The CCM data 311 can include detailed information about CPU utilization, IOPS, response times, power consumption, and other relevant metrics of the primary storage array 102. The CCM data 311 can also include predictive analytics, providing insights into expected workload patterns and resource needs to process the replication workloads 303 at any given time. Thus, the RDF 104, via an RDF controller 342, can analyze the CCM data 311 to determine how resources are allocated and managed at the primary storage array 102. The analysis can include identifying patterns in resource usage during peak and off-peak times and during different types of operations (e.g., heavy read or write periods).

The RDF controller 342 can also generate a local RDF CCM 313 by assessing the hardware and software capabilities of the RDF 104, including the number of available CPU cores, memory capacity, network bandwidth, and storage capabilities. For example, the RDF controller 342 can assess current resource utilization levels to determine the available capacity for handling additional or fluctuating workloads. Based on its resource assessment and operational requirements, the RDF controller 342 can generate the local RDF CCM 313, categorizing the RDF's CPU cores 344 into different pools (e.g., Diamond, Gold, Silver, Bronze) according to their performance characteristics and intended usage. Thus, the RDF controller 342 can initially configure the local RDF CCM 313 to handle anticipated local workloads (e.g., the local workloads 302) and to provide a baseline for integrating the CCM data 311 of the primary storage array 102.

In embodiments, the RDF controller 342 can integrate the data corresponding to the CCM data with the local RDF CCM 313 by aligning their respective resource allocation strategies and performance benchmarks to ensure consistency across both sites (e.g., the primary storage array 102 and the RDF 104). The data integration process considers factors such as mirroring the primary storage array's resource distribution to handle replication workloads and maintain data consistency effectively.

In embodiments, the RDF controller 342 can generate a composite CCM 314 using the CCM data 311 corresponding to the storage array 102 and the local RDF CCM 313. For example, the RDF controller 342 can merge the RDF's local resource management strategies with the predictive insights and operational patterns derived from the primary array's CCM data 311. Accordingly, the composite CCM 314 can provide a unified view of how resources should be allocated and managed to optimize performance, reduce costs, and ensure SLA compliance.

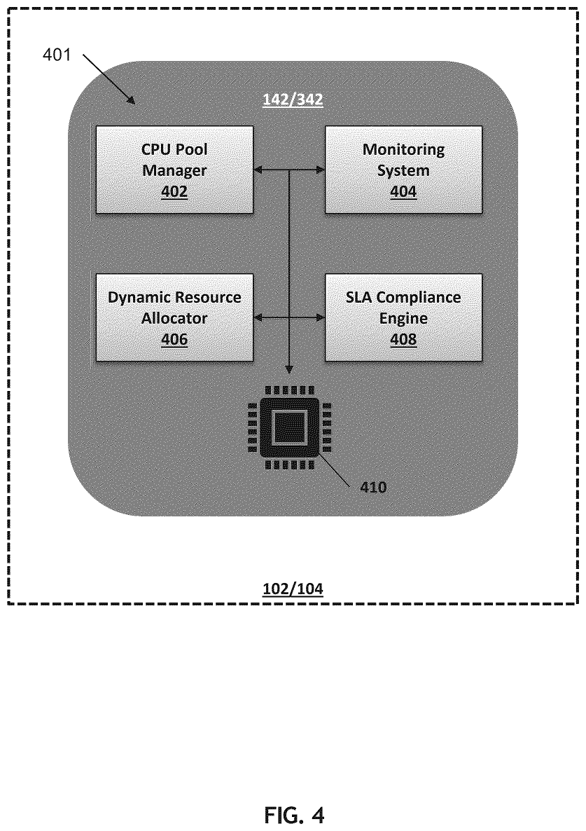

Regarding FIG. 4, the storage array/RDF 102/104 can include respective controllers 142/342 configured to provide flexible, dynamic control over CPU resources based on real-time demands and predefined service levels. For example, the controllers 142/342 can include logic, circuitry, and hardware components 401 that monitor, analyze, and adjust CPU allocations and settings across a distributed data storage system.

In embodiments, the controllers 142/342 can include a CPU pool manager 402 configured to dynamically organize and manage CPU resources to meet varying workload demands effectively. For instance, the CPU pool manager 402 can categorize CPU cores (e.g., the cores 144/344 of FIG. 3) into distinct pools, each tailored to specific performance and power consumption profiles, such as Diamond, Gold, Silver, and Bronze. Thus, the CPU pool manager 402 can dynamically assign and reassign CPU cores to different pools based on current workload demands and SLA requirements, ensuring optimal resource utilization and performance.

To that end, functionalities of the CPU pool manager 402 can include resource categorization, dynamic resource allocation, and performance optimization. Resource categorization can include organizing CPU cores into pools based on, e.g., predefined criteria. For instance, each pool can be designed to support a specific type of workload, characterized by its performance sensitivity and priority. Thus, each pool can correspond to different service levels, ensuring that resources are aligned with the operational priorities and SLAs. Dynamic resource allocation can include performing adaptive resource allocation and load-balancing techniques. For example, the CPU pool manager 402 can dynamically allocate and reallocate CPU cores among different pools based on real-time workload demands and system performance metrics. Accordingly, the CPU pool manager 402 can ensure optimal distribution of computing resources to maintain balance across workloads, preventing overutilization or underutilization of CPU cores. Performance optimization can include adjusting CPU clock speeds and power settings in response to fluctuating workload demands to enhance energy efficiency without compromising performance.

In embodiments, the CPU pool manager 402 can continuously gather data on CPU performance, including utilization rates, process queue lengths, and power consumption via, e.g., the monitoring system 404. The CPU pool manager 402 can analyze this data to identify trends and patterns, such as peak usage times or potential bottlenecks. Further, the CPU pool manager 402 can determine how to allocate CPU cores, which includes promoting or demoting cores between pools to respond to changing demands. Additionally, the CPU pool manager 402 can adjust CPU clock speeds to conserve energy or boost performance, depending on current needs. Moreover, the CPU pool manager 402 can implement the determinations by physically reallocating CPU cores and adjusting settings.

In embodiments, the controllers 142/342 can include a monitoring system 404 configured to provide real-time insights into system operations, detect potential issues before they escalate, and support data-driven decision-making for resource allocation and system adjustments. Thus, the monitoring system 404 can gather data on numerous performance indicators such as CPU utilization, memory usage, IOPS (Input/Output Operations Per Second), throughput, latency, and error rates. For example, the monitoring system 404 can employ sensors and agents (e.g., daemons (not shown)), communicatively coupled to one or more components of the storage array 102 or RDF 104, to continuously gather the performance data. Further, the monitoring system 404 can finely tune monitoring intervals to balance real-time responsiveness and timely data collection.

Further, the monitoring system 404 can aggregate and process the collected data to produce actionable insights. For example, the monitoring system 404 can collect the data over time to identify trends and patterns that can indicate emerging issues or opportunities for optimization. Thus, the data aggregation can involve statistical analysis, machine learning models, or heuristic algorithms. In addition, the monitoring system 404 can use historical/current data and predictive modeling to forecast future system behavior and performance trends. As such, the monitoring system 404 can generate workload models and store them in a local memory 410. Additionally, the monitoring system 404 can generate local CCMs defining CPU core allocations.

In embodiments, the controllers 142/342 can include a dynamic resource allocator 406 that dynamically analyzes workload characteristics and performance data to adjust CPU resources across the pools. Specifically, the dynamic resource allocator 406 is configured to dynamically manage and allocate various types of resources, such as CPU, memory, storage, and network bandwidth, based on current workload demands and system conditions. For example, the dynamic resource allocator 406 can handle the promotion and demotion of CPU cores between pools to match the changing demands of the system. Specifically, the dynamic resource allocator 406 can adjust CPU allocations in real-time, increasing or decreasing CPU clock speeds or shifting cores between pools to optimize performance and power usage based on the analysis from the monitoring system 404.

Suppose, for example, the monitoring system 404 detects that the response time for a storage group categorized under the Gold SL has consistently exceeded its target of 0.6 millisecond response times. Accordingly, the monitoring system 404 can trigger an alert indicating that the Gold storage group's response time SLA is not being met. The dynamic resource allocator 406 can receive the alert with detailed performance data to begin an assessment.

For example, the dynamic resource allocator 406 can analyze metrics across all CPU pools and determine that the Gold CPU pool is overutilized (high CPU usage and long queue lengths) while the Silver pool is underutilized. Based on the analysis, the dynamic resource allocator 406 can reallocate CPU cores from the Silver pool to the Gold pool to improve response times for the Gold storage group. The decision to reallocate the CPU cores can consider factors such as the minimal impact on Silver SLAs and the potential significant improvement in Gold SLAs. In embodiments, the CPU pool manager 402 can ensure the reallocation does not cause the Silver Pool to not meet its SLA requirements by establishing a minimum CPU core threshold for each service level.

In embodiments, the controllers 142/342 can include a Service Level Agreement (SLA) Compliance Engine 408 configured to continuously monitor, evaluate, and ensure that all operational parameters meet the agreed-upon standards specified in SLAs with clients or internal business units. The SLA compliance engine 408 can define and configure SLA parameters based on customer agreements. The agreements can establish key performance indicators (KPIs), thresholds, and monitoring intervals for each SLA metric. Accordingly, the SLA compliance engine 408 can obtain the necessary data for evaluating SLA compliance from the monitoring system 404.

For example, the SLA compliance engine 408 can use the data from the monitoring system 404 to track various performance metrics such as response times, throughput, availability, and error rates against predefined SLA thresholds. Additionally, the SLA compliance engine 408 can monitor the usage of resources like CPU, memory, and storage to ensure they are optimally utilized per what is stipulated in the SLAs. Further, the SLA compliance engine 408/can automatically generate alerts when SLA parameters are at risk of being breached, allowing for quick remedial actions before actual breaches occur.

Suppose, for example, an IT service provider has an SLA with a client that specifies a maximum response time of 200 milliseconds (ms) of the storage array 102 or RDF 104 for a critical application. The SLA compliance engine 408 can continuously monitor response times for IO operations corresponding to the application. Upon detecting a trend towards a threshold response time limit, the SLA compliance engine 408 can trigger predefined corrective actions, such as reallocating additional CPU resources from less critical applications or triggering additional instances of the application.

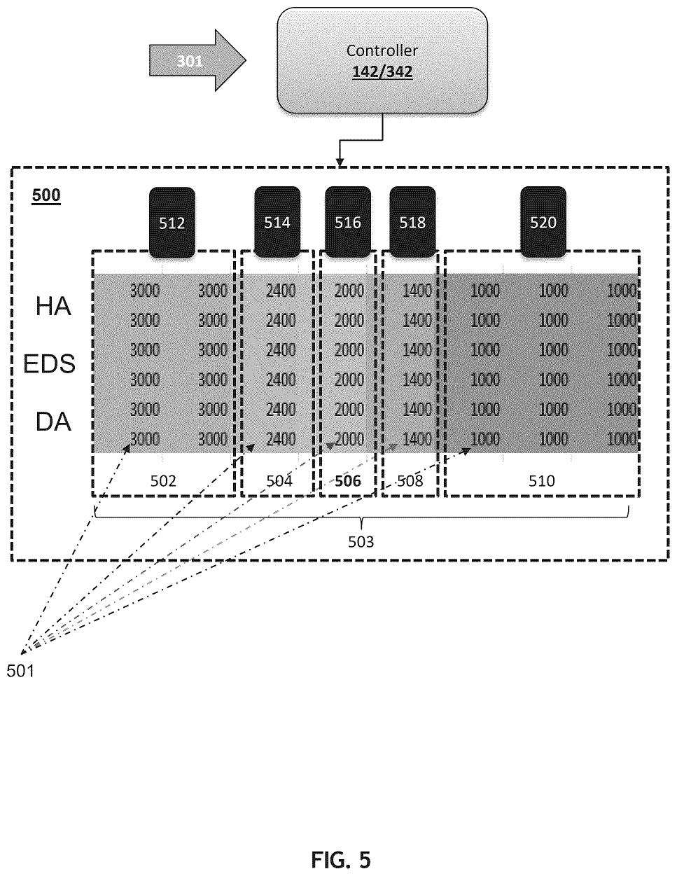

Regarding FIG. 5, a controller 142/342 can include logic, hardware, and circuitry configured to process one or more IO workloads 301 and their respective IO operations. In embodiments, the controller 142/342 can establish a composable CPU core matrix (CCM) 500 (e.g., substantially similar to the CCMs 311, 313, and 314 of FIG. 3) to dynamically manage and optimize the allocation and utilization of CPU resources within a storage array, particularly in environments like Remote Data Facility (RDF) systems (e.g., the RDF 104 of FIG. 3).

The CCM 500 can group CPU cores 501 into one or more pools 503. The pools 503 can include a Diamond Pool 502, Platinum Pool 504, Gold Pool 506, Silver Pool 508, and Bronze Pool 510. Further, the CCM 500 can define the clock speeds in megahertz (Mhz), target response times (in milliseconds (ms), IOPS per core, and watts for each service level (SL) per the example Service Level Core Profile Table below.

| SL | Mhz | Tgt Ms | IOPS/core | Watts |
|---|---|---|---|---|
| Diamond | 3000 | 0.1 | 10000 | 6.25 |
| Platinum | 2400 | 0.2 | 5000 | 3.13 |
| Gold | 2000 | 0.6 | 1667 | 1.04 |
| Silver | 1400 | 1.2 | 833 | 0.52 |
| Bronze | 1000 | 2.5 | 400 | 0.25 |

Service Level Core Profile Table

Thus, the CCM 500 assigns each CPU pool 502, 504, 506, 508, 510, and their respective CPU cores 501 to specific service level requirements that dictate the performance metrics like response time and throughput (IOPS-Input/Output Operations Per Second). As described above, the controller 142/342 can use the CCM 500 to dynamically adjust the number of CPU cores and their clock speeds based on real-time workload demands. The workload demands can include both local and replication IO operations. Using the CCM 500 to adjust clock speeds and the number of active CPU cores 501, the controller 142/342 can significantly reduce power consumption.

In embodiments, the controller 142/342 can use the CCM 500 to continuously assess the workload demands of a storage array or RDF (e.g., the storage array 102 and RDF 104 of FIG. 3). In particular, the controller 142/342 can categorize the workload demands into different service levels, and adjust CPU resources accordingly, For example, during peak load times, the controller 142/342 can include the CPU resources allocated to high-priority tasks (e.g., Diamond level SLs) to maintain performance while reducing resources for lower-priority tasks to conserve energy.

In addition, the controller 142/342 can establish IO queues 512, 514, 516, 518, and 520 for each CPU pool 502, 504, 506, 508, 510. Accordingly, the controller 142/342 can differentiate each IO queue 512, 514, 516, 518, and 520 based on service level agreements (SLAs) that dictate performance requirements such as response time and throughput. Further, the controller 142/342 can establish a queue depth (e.g., the maximum number of IO operations that can be held in a queue at any one time) for each IO queue 512, 514, 516, 518, and 520. The controller 142/342 can configure the queue depths based on expected workloads and the performance capabilities of the CPU cores 501 corresponding to each SL. CPU pools corresponding to higher service levels (e.g., the Diamond Pool 502) can have deeper queues to accommodate high-priority IO operations without delays.

In embodiments, the controller 142/342 can classify each IO operation corresponding to an IO workload 301 based on, e.g., its source and intended service level. For example, the controller 142/342 can provide an IO operation with an SL classification based on its origin (e.g., a specific application or user group) and the criticality of the IO operation's corresponding data. Once an IO operation is classified, the controller 142/342 can dispatch it to the IO queue associated with an SL corresponding to the IO operation's classification.

Further, the controller 142/342 can use the CCM 500 to load balance IO operations evenly across or between one or more of the IO queues 512, 514, 516, 518, and 520 to optimize performance and prevent any single queue from becoming a bottleneck. For instance, the controller 142/342 can monitor the IO queues 512, 514, 516, 518, and 520 to ensure their respective depths do not exceed corresponding queue thresholds. If one or more of the IO queues 512, 514, 516, 518, and 520 approach or reach their corresponding queue thresholds, the controller 142/342 can use the CCM 500 to mitigate potential performance degradation. For example, the controller 142/342 can temporarily increase the queue depth to accommodate a surge in IO requests, shift CPU resources from less critical queues to the overloaded queue to process IO requests more quickly, or redirect new incoming IO requests to other queues with similar service levels but lower utilization, ensuring continued adherence to SLAs.

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

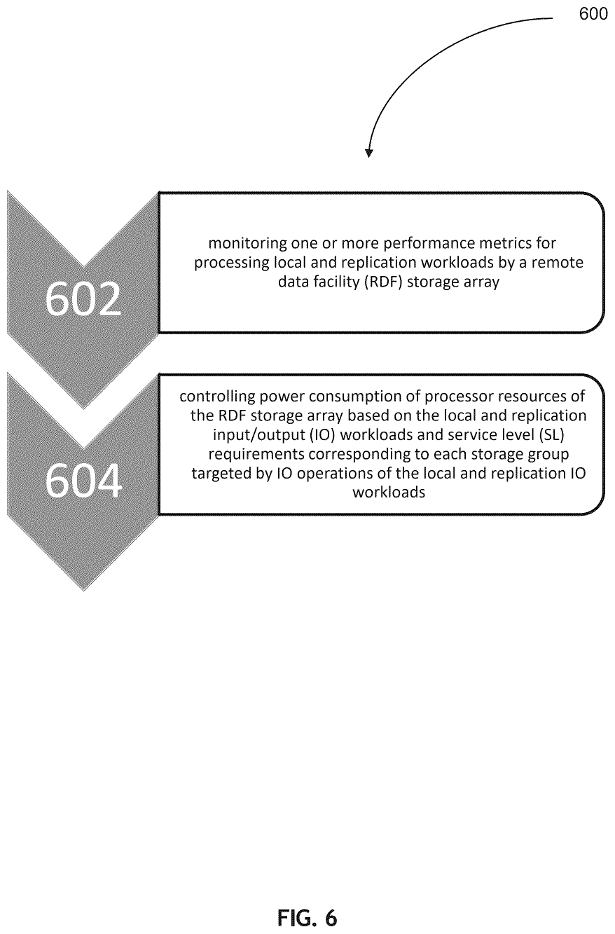

Regarding FIG. 6, a method 600 relates to controlling the power consumption of processor resources. In embodiments, the controller 142 of FIG. 1 can perform all or a subset of operations corresponding to the method 500.

For example, the method 600, at 602, can include monitoring one or more performance metrics for processing local and replication workloads by a remote data facility (RDF) storage array. Additionally, at 604, the method 600 can include controlling the power consumption of processor resources of the RDF storage array based on the local and replication input/output (IO) workloads and service level (SL) requirements corresponding to each storage group targeted by IO operations of the local and replication IO workloads.

Further, each operation can include any combination of techniques implemented by the embodiments described herein. Additionally, one or more of the storage array's components 108 can implement one or more of the operations of each method described above.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

What is claimed is:

1. A method comprising:
monitoring one or more performance metrics for processing local and replication workloads by a remote data facility (RDF) storage array; and
controlling power consumption of processor resources of the RDF storage array based on the local and replication input/output (IO) workloads and service level (SL) requirements corresponding to each storage group targeted by IO operations of the local and replication IO workloads.

2. The method of claim 1, further comprising:
periodically receiving, by the RDF storage array, a composable core matrix (CCM) defining processor resource allocations of a source storage array of the replication workloads.

3. The method of claim 2, further comprising:
determining SL assignments of each central processing unit (CPU) pool of the source storage array using the CCM of the source storage array; and
determining CPU core allocations per CPU pool of the source storage array using the CCM of the source storage array, wherein the CCM defines the CPU core allocations of each CPU pool based on historical, current, and forecasted IO workload demands and response times of each storage group corresponding to the source storage array.

4. The method of claim 3, wherein the historical, current, and forecasted IO workload demands correspond to input/output (IO) operations per second (IOPS) corresponding to each storage group.

5. The method of claim 4, further comprising:
determining CPU clock speed settings corresponding to each CPU pool of the source storage array using the CCM of the source storage array.

6. The method of claim 6, further comprising:
forecasting IOPS demand and response times corresponding to each storage group of the RDF storage array based on the monitored performance metrics of the local workloads processed by the RDF storage array.

7. The method of claim 6, further comprising:
generating a composite CCM corresponding to the RDF storage array using the CCM of the source storage array and the forecasted IOPS demand and response times corresponding to each storage group of the RDF storage array, wherein the CCM controls processor power consumption by defining the CPU clock speed settings corresponding to each CPU pool of the RDF storage array.

8. The method of claim 7, further comprising:
generating the composite CCM to define CPU pools for each SL requirement and adjustments to CPU core allocations amongst the CPU pools based on the CCM of the source storage array and the forecasted IOPS demand and response times corresponding to each storage group of the RDF storage array.

9. The method of claim 8, further comprising:
dynamically promoting or demoting CPU cores amongst the CPU pools to satisfy SL response time targets corresponding to each storage group of the RDF storage array using the composite CCM.

10. The method of claim 9, further comprising:
increasing a CPU core allocation of a subject CPU pool when one or more storage groups corresponding to the subject CPU pool are above response time targets; and
decreasing the CPU core allocation of the subject CPU pool when one or more storage groups corresponding to the subject CPU pool are below response time targets while maintaining a baseline threshold of CPU cores for the subject CPU pool.

11. An apparatus with a memory and processor, the apparatus configured to:
monitor one or more performance metrics for processing local and replication workloads by a remote data facility (RDF) storage array; and
control power consumption of processor resources of the RDF storage array based on the local and replication input/output (IO) workloads and service level (SL) requirements corresponding to each storage group targeted by IO operations of the local and replication IO workloads.

12. The apparatus of claim 11, further configured to:
periodically receive, by the RDF storage array, a composable core matrix (CCM) defining processor resource allocations of a source storage array of the replication workloads.

13. The apparatus of claim 12, further configured to:
determine SL assignments of each central processing unit (CPU) pool of the source storage array using the CCM of the source storage array; and
determine CPU core allocations per CPU pool of the source storage array using the CCM of the source storage array, wherein the CCM defines the CPU core allocations of each CPU pool based on historical, current, and forecasted IO workload demands and response times of each storage group corresponding to the source storage array.

14. The apparatus of claim 13, wherein the historical, current, and forecasted IO workload demands correspond to input/output (IO) operations per second (IOPS) corresponding to each storage group.

15. The apparatus of claim 14, further configured to:
determine CPU clock speed settings corresponding to each CPU pool of the source storage array using the CCM of the source storage array.

16. The apparatus of claim 16, further configured to:
forecast IOPS demand and response times corresponding to each storage group of the RDF storage array based on the monitored performance metrics of the local workloads processed by the RDF storage array.

17. The apparatus of claim 16, further configured to:
generate a composite CCM corresponding to the RDF storage array using the CCM of the source storage array and the forecasted IOPS demand and response times corresponding to each storage group of the RDF storage array,
wherein the CCM controls processor power consumption by defining the CPU clock speed settings corresponding to each CPU pool of the RDF storage array.

18. The apparatus of claim 17, further configured to:
generate the composite CCM to define CPU pools for each SL requirement and adjustments to CPU core allocations amongst the CPU pools based on the CCM of the source storage array and the forecasted IOPS demand and response times corresponding to each storage group of the RDF storage array.

19. The apparatus of claim 18, further configured to:
dynamically promote or demote CPU cores amongst the CPU pools to satisfy SL response time targets corresponding to each storage group of the RDF storage array using the composite CCM.

20. The apparatus of claim 19, further configured to:
increase a CPU core allocation of a subject CPU pool when one or more storage groups corresponding to the subject CPU pool are above response time targets; and
decrease the CPU core allocation of the subject CPU pool when one or more storage groups corresponding to the subject CPU pool are below response time targets while maintaining a baseline threshold of CPU cores for the subject CPU pool.
